(19) United States
(12) Patent Application Publication
(10) Pub. No.: US 2015/0002358 A1
(43) Pub. Date: Jan. 1, 2015

(54) RADIO COMMUNICATION MODULE

(71) Applicant: SAMSUNG ELECTRO-MECHANICS CO.. LTD., Gyeonggi-Do (KR)

(72) Inventors: Hee Sun OH, Gyeonggi-Do (KR); Hee Jun PARK, Gyeonggi-Do (KR); Gye Won LEE, Gyeonggi-Do (KR); Jong Yun KIM, Gyeonggi-Do (KR)

(73) Assignee: SAMSUNG ELECTRO-MECHANICS CO., LTD., Gyeonggi-Do (KR)

(21) Appl. No.: 14/317,578

(22) Filed: Jun. 27, 2014

(30) Foreign Application Priority Data
Jun. 28, 2013 (KR) 10-2013-0075653
Jul. 26, 2013 (KR) 10-2013-0089057
Jun. 16, 2014 (KR) 10-2014-0072918

(51) Int. Cl. H01Q 1/52

(52) U.S. Cl. CPC H01Q 1/526
USPC 343/841

(57) ABSTRACT

Embodiments of the invention provide a radio communication module, including a printed circuit board including a receiving connector, a shield can provided on the printed circuit board and configured to shield an electromagnetic wave, and an antenna including a transmitting connector connected to the receiving connector and connected to the printed circuit board through the transmitting connector. The shield can includes a blocking part formed at one side surface thereof and protruding toward the transmitting connector and the receiving connector.

### CROSS REFERENCE TO RELATED APPLICATION

This application claims the benefit of and priority under 35 U.S.C. §119 to Korean Patent Application Nos. KR 10-2013-0075653, entitled “RADIO COMMUNICATION MODULE,” filed on Jun. 28, 2013, KR-2013-0089057, entitled “RADIO COMMUNICATION MODULE,” filed on Jul. 26, 2013, and KR 10-2014-0072918, entitled “RADIO COMMUNICATION MODULE,” filed on Jun. 16, 2014, which are hereby incorporated by reference in their entirety into this application.

### BACKGROUND

1. Field of the Invention

The present invention relates to a radio communication module.

2. Description of the Related Art

Wi-Fi generally is a wireless local area network (WLAN) technology enabling high performance radio communication by combining a wireless technology with High fidelity. The WLAN means a scheme of building a network using, for example, an electric wave, light, without using a wire at the time of building the network.

Therefore, a radio communication module in the Wi-Fi is used, such that a product for consumer electronics (CE) including a set-top box, a television (TV), a printer, and a notebook computer may be wirelessly connected and used.

The product for CE includes an antenna (ANT) playing an important role in performance of the Wi-Fi. Generally, the antenna is connected to the radio communication module using a UFL connector.

However, in the case in which the antenna (ANT) is simply connected to the radio communication module, when abnormal impact is applied from the outside to the product for CE having the radio communication module embedded therein, a detaching phenomenon occurs, such that the antenna (ANT) may be separated from the radio communication module.

In order o solve this problem, Korean Patent Application No. KR 10-2006-0136564 (“Yoon”) has disclosed that in mounting an antenna connector on a printed circuit board of a radio communication module and then connecting a radio frequency (RF) cable connector to the antenna connector to connect an antenna to the radio communication module, a protrusion and a groove are formed in the antenna connector and the RF cable connector, respectively, and are coupled to each other to prevent the antenna from being separated from the radio communication module.

In addition, Yoon discloses a hole that is drilled in the printed circuit board, and a cable of the antenna passes through the hole to prevent detachment of the antenna, or the cable is soldered to the printed circuit board to prevent detachment of the antenna. However, in this scheme, workability is significantly decreased at the time of mass production, and an additional process is required, which causes a cost increase.

### SUMMARY

Accordingly, embodiments of the invention have been made to solve a problem that an antenna is separated from a radio communication module when abnormal impact is generated.

Accordingly, embodiments of the invention have been made to solve the above-mentioned problems, and therefore provide a radio communication module from which separation of an antenna may be easily prevented.

According to various embodiments of the invention, there is provided a radio communication module including a printed circuit board having a receiving connector, a shield can provided on the printed circuit board and shielding an electromagnetic wave, and an antenna including a transmitting connector connected to the receiving connector and connected to the printed circuit board through the transmitting connector. According to at least one embodiment, the shield can includes a blocking part formed at one side surface thereof and protruding toward the transmitting connector and the receiving connector.

The radio communication module according to at least one embodiment includes various circuit devices mounted therein for Wi-Fi connection by way of example, and includes a printed circuit board including a receiving connector, an antenna connected to the printed circuit board through a transmitting connector connected to the receiving connector, and a shield can provided on the printed circuit board and shielding an electromagnetic wave.

According to at least one embodiment, the radio communication module is embedded and used in, for example, an electronic product for consumer electronics (CE) including, for example, a set-top box (STB), a television (TV), a printer.

According to at least one embodiment, the receiving connector and the transmitting connector, which are components connecting, the antenna corresponding to a necessary component of the radio communication module to the printed circuit board, are generally a UFL connector.

According to at least one embodiment, the shield can, which is formed, for example, of a metal including aluminum and is configured to protect various circuit devices, mounted on the printed circuit board through electromagnetic wave shielding due to characteristics of this metal, prevents the transmitting connector from being detached from the receiving connector together with the electromagnetic wave shielding.

According to at least one embodiment, the shield can includes a blocking part formed at one side surface thereof and protruding toward the transmitting connector and the receiving connector. Here, the blocking part is disposed adjacent to the transmitting connector regardless of a height of the shield can, and includes a reinforcing structure formed in order to reinforce strength and a support structure formed to order to prevent a distal end thereof from sagging.

Therefore, in the radio communication module according to at least one embodiment of the invention, separation of the antenna due to a detachment phenomenon may be easily prevented as compared with a conventional radio communication module, such that work efficiency may be improved and deterioration of performance may be prevented.

According to another embodiment of the invention, there is provided a radio communication module including a printed circuit board including a receiving connector, and an antenna including a transmitting connector connected to the receiving connector and connected to the printed circuit board through the transmitting connector. According to at least one embodiment, the transmitting connector includes a latching part formed toward the printed circuit board, and a fixing part to which the latching part is coupled is formed in the printed circuit board. In accordance with another embodiment, the transmitting connector includes a latching part formed toward the shield can, and a fixing part to which the latching part is coupled is formed in the shield can. In accordance with another embodiment, the transmitting connector includes latching parts formed toward the printed circuit board and the shield can, respectively, and fixing parts to which the latching parts are coupled are formed in the printed circuit board and the shield can, respectively.

According to at least one embodiment, the latching part is coupled to the fixing part formed in the printed circuit board or the shield can by an elastic action due to characteristics of a material thereof to prevent detachment of the transmitting connector. The latching part is partially or entirely rounded so that this elastic action is easily performed.

Therefore, in the radio communication module according to another embodiment of the invention, a coupling feature between the transmitting connector and the receiving connector is improved as compared with a conventional radio communication module, thereby preventing a detachment problem between the transmitting connector and the receiving connector in advance. In addition, through this, a ground is reinforced to increase stability of a signal.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a partially enlarged front view of a radio communication module according to a first embodiment of the invention.

FIG. 2 is a plan view generally showing the radio communication module according to the first embodiment of the invention.

FIG. 3 is a plan view generally showing a radio communication module according to a second embodiment of the invention.

FIG. 4 is a partially enlarged front view of a radio communication module according to a third embodiment of the invention.

FIG. 5 is a partially enlarged front view of a radio communication module according to a fourth embodiment of the invention.

FIG. 6 is a partially enlarged front view of a radio communication module according to a fifth embodiment of the invention.

FIG. 7 is a partially enlarged cross-sectional view of a radio communication module according to a sixth embodiment of the invention.

FIG. 8 is a plan view generally showing the radio communication module according to the sixth embodiment of the invention.

FIG. 9 is a partially enlarged cross-sectional view of a radio communication module according to a seventh embodiment of the invention.

FIG. 10 is a plan view generally showing the radio communication module according to the seventh embodiment of the invention.

FIG. 11 is a partially enlarged cross-sectional view of a radio communication module according to an eighth embodiment of the invention.

FIG. 12 is a plan view generally showing the radio communication module according to the eighth embodiment of the invention.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

Hereinafter, various embodiments of the present invention will be described in detail with reference to the accompanying drawings.

### First Embodiment

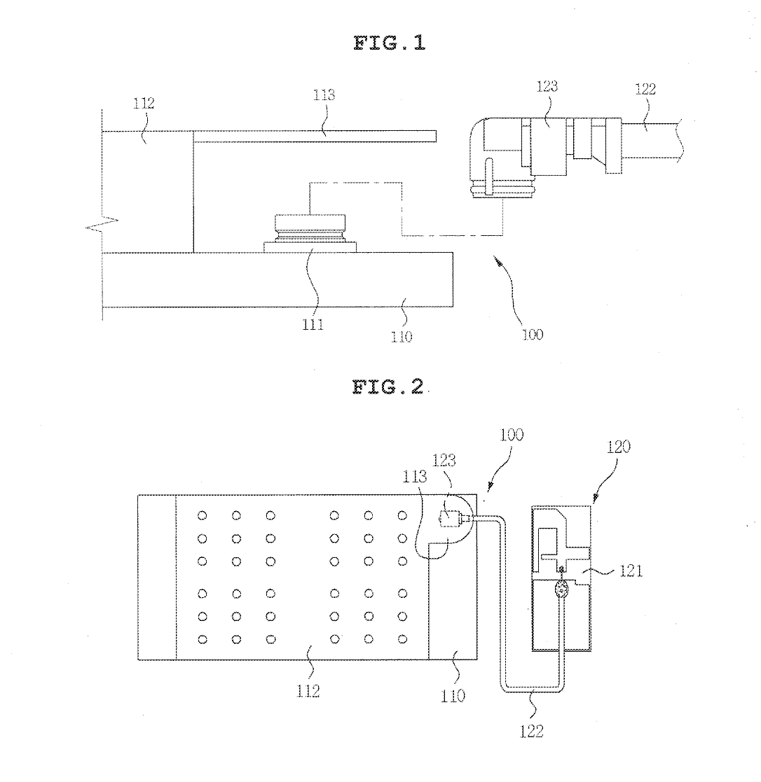

As shown in FIGS. 1 and 2, a radio communication module 100, according to a first embodiment of the invention, is configured to include a printed circuit board 110 including a receiving connector 111, a shield can 112 provided on the printed circuit board 110 and shielding, for example, an electromagnetic wave, an antenna 120 including a transmitting connector 123 connected to the receiving connector 111, and a blocking part 113 formed at a side of one side surface of the shield can 112, so as to protrude toward the transmitting connector 123 and the receiving connector 111.

According to an embodiment, the printed circuit board 110 includes a general UFL connector mounted as the receiving connector 111 on a substrate, the shield can 112 is installed at one side of the receiving connector 111 and made, for example, of a metal, and the blocking part 113 is formed at a side of the right of the shield can 112 in FIGS. 1 and 2.

According to an embodiment, the antenna 120 is configured as a module by connecting a UFL connector formed in a circular shape using a thin copper plate as the transmitting connector 123 to a front end of a cable 122 and soldering and mounting the other end of the cable 122 to and on an antenna board 121.

According to an embodiment, the blocking part 113 protrudes at one side surface of the shield can 112 and is disposed above the transmitting connector 123 and the receiving connector 111 at the time of connecting the transmitting connector 123 to the receiving connector 111, thereby making it possible to easily prevent the transmitting connector 123 from being detached from the receiving connector 111. As a result, separation of the antenna 120 is effectively prevented to prevent deterioration of performance.

### Second Embodiment

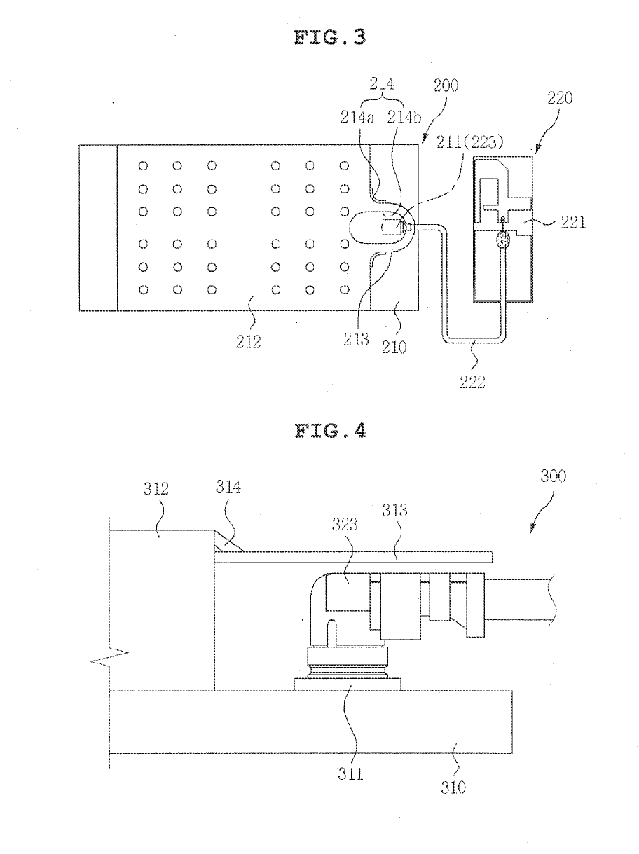

As shown in FIG. 3, a radio communication module 200, according to a second embodiment of the invention, is configured to include a printed circuit board 210 including a receiving connector 211, a shield can 212 provided on the printed circuit board 210 and shielding, for example, an electromagnetic wave, an antenna 220 including a transmitting connector 223 connected to the receiving connector 211, and a blocking part 213 formed at a central portion of one side surface of the shield can 212, so as to protrude toward the transmitting connector 223 and the receiving connector 211.

According to an embodiment, the printed circuit board 210 includes a general UFL connector mounted as the receiving connector 211 on a substrate, the shield can 212 is installed at one side of the receiving connector 211 and made, for example, of a metal, and the blocking part 213 is formed at the center of the right of the shield can 212 in FIG. 3.

According to an embodiment, the antenna 220 is configured as a module by connecting a UFL connector formed in a circular shape using a thin copper plate as the transmitting connector 223 to a front end of a cable 222 and soldering and mounting the other end of the cable 222 to and on an antenna board 221.

According to an embodiment, a distal end of the left of the blocking part 213, as shown in FIG. 3, is connected to an upper portion of the shield can 212. However, a sag phenomenon occurs due to absence of a connection structure at a distal end of the right of the blocking part 213 to cause electric wave interference due to a contact between the blocking part 213 and the transmitting connector 223 or generate breaking, for example, due to a contact between the blocking part 213 and a peripheral apparatus. Therefore, a reinforcing part 214 is formed in order to reinforce strength.

According to an embodiment, the reinforcing part 214, which is to structurally reinforce the strength of the blocking part 213 generally formed of a thin plate, includes a rib 214a formed at an outer portion at which the shield can 212 and the blocking part 213 are connected to each other. As an example, the rib 214a is integrally formed and protrudes at one side surfaces of the shield can 212 and the blocking part 213 in a process of pressing and forming the shield can 212 to prevent the sag, the breaking, for example, of the blocking part 213.

According to an embodiment, the reinforcing part 214 is formed in the blocking part 214, which may be easily implemented by bending a portion of a plate in a direction toward the printed circuit board 210 or a direction opposite to the direction toward the printed circuit board 210 in a process of forming the blocking part 213 to form a concave-convex part 214b. Thus, the concave-convex part 214b formed by structurally bending the blocking part 213 formed of a thin plate prevents the sag or the breaking of the blocking part 213.

According to an embodiment, the reinforcing part 213 include any one of the rib 214a and the concave-convex part 214b or includes both of them.

According to an embodiment, the strength of the blocking part 213 connected to the upper portion of the shield can 212, protruding at one side surface of the shield can 212, and disposed above the transmitting connector 223 and the receiving connector 211 to easily prevent the transmitting connector 223 from being detached from the receiving connector 211, is easily structurally reinforced by the reinforcing part 214. As a result, separation of the antenna 220 due to an external factor is effectively prevented to prevent deterioration of performance.

### Third Embodiment

As shown in FIG. 4, a radio communication module 300, according to a third embodiment of the invention, is configured to include a printed circuit board 310 including a receiving connector 311, a shield can 312 provided on the printed circuit board 310 and shielding, for example, an electromagnetic wave, an antenna (ANT) including a transmitting connector 323 connected to the receiving connector 311, and a blocking part 313 formed at a central portion of one side surface of the shield can 312, so as to protrude toward the transmitting connector 323 and the receiving connector 311.

According to an embodiment, the antenna (ANT) is substantially the same as the antenna according to the first embodiment of the invention described above. Therefore, the antenna (ANT) is not shown in FIG. 4, and a detailed description of the antenna (ANT) will be omitted.

According to an embodiment, the printed circuit board 310 includes a general UFL connector mounted as the receiving connector 311 on a substrate, the shield can 312 is installed at one side of the receiving connector 311 and made, for example, of a metal, and the blocking part 313 is formed at the center of the right of the shield can 312 in FIG. 4.

According to an embodiment, the blocking part 313 is formed integrally with a bent part 314 bent downwardly from an edge of the shield can 312 toward the printed circuit board 310 in consideration of a height difference between the shield can 312 and the transmitting and receiving connectors 323 and 311, such that it is configured to be adjacent to upper portions of the transmitting and receiving connectors 323 and 311.

According to an embodiment, the blocking part 313 is disposed adjacent to the upper portion of the transmitting connector 323 connected to the receiving connector 311, thereby making it possible to easily prevent the transmitting connector 323 from being detached from the receiving connector 311. As a result, separation of the antenna (ANT) is effectively prevented to prevent deterioration of performance.

### Fourth Embodiment

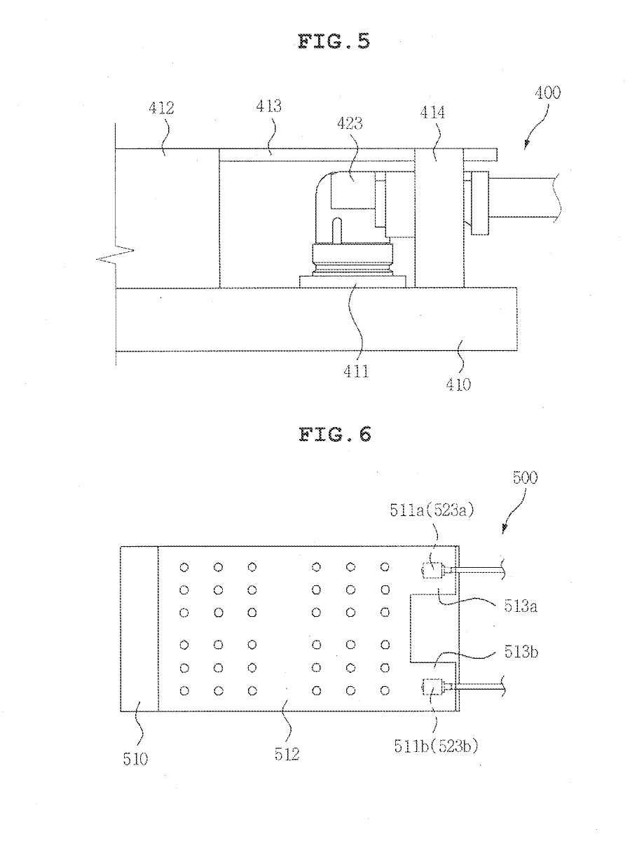

As shown in FIG. 5, a radio communication module 400, according to a fourth embodiment of the invention, is configured to include a printed circuit board 410 including a receiving connector 411, a shield can 412 provided on the printed circuit board 410 and shielding, for example, an electromagnetic wave, an antenna (ANT) including a transmitting connector 423 connected to the receiving connector 411, and a blocking part 413 formed at a central portion of one side surface of the shield can 412, so as to protrude toward the transmitting connector 423 and the receiving connector 411.

According to an embodiment, the antenna (ANT) is substantially the same as the antenna according to the first embodiment of the invention described above. Therefore, the antenna (ANT) is not shown in FIG. 5, and a detailed description of the antenna (ANT) will be omitted.

According to an embodiment, the printed circuit board 410 includes a general UFL connector mounted as the receiving connector 411 on a substrate, the shield can 412 is installed at one side of the receiving connector 411 and made, for example, of a metal, and the blocking part 413 is formed at the center of the right of the shield can 412 in FIG. 5.

In addition, a distal end of the left of the blocking part 413, as shown in FIG. 5, is connected to the shield can 412. However, a sag phenomenon occurs due to absence of a connection structure at a distal end of the right of the blocking part 413, thereby making it possible to cause electric wave interference due to a contact between the blocking part 413 and the transmitting connector 423. Therefore, a support part 414 is bent toward the printed circuit board 410 is formed at a side surface of the blocking part 413.

According to an embodiment, the blocking part 413 prevents detachment of the transmitting connector 423 connected to the receiving connector 411, and the sag of the blocking part 413 may be easily prevented. As a result, deterioration of performance is effectively prevented.

### Fifth Embodiment

As shown in FIG. 6, a radio communication module 500, according to a fifth embodiment of the invention, is configured to include a printed circuit board 510 including receiving connectors 511a and 511b, a shield can 512 provided on the printed circuit board 510 and shielding, for example, an electromagnetic wave, an antenna (ANT) including transmitting connectors 523a and 523b connected to the receiving connectors 511a and 511b, respectively, and blocking parts 513a and 513b formed at both sides of one side surface of the shield can 512, respectively, to protrude toward the receiving connectors 511a and 511b and the transmitting connectors 523a and 523b.

According to an embodiment, the antenna (ANT) is substantially the same as the antenna according to the first embodiment of the invention described above except that the number thereof is plural. Therefore, the antenna (ANT) is not shown in FIG. 5, and a detailed description of the antenna (ANT) will be omitted.

According to an embodiment, the printed circuit board 510 includes a plurality of general UFL connectors mounted as the receiving connectors 511a and 511b on a substrate and the shield can 512 installed at one sides of the receiving connectors 511a and 511b and made, for example, of a metal, and the blocking parts 513a and 513b are formed at both sides of the right of the shield can 512 in FIG. 6 to be spaced apart from each other.

According to an embodiment, the blocking parts 513a and 513b protruding on both sides of the shield can 512, respectively, are disposed above the transmitting connectors 523a and 523b, respectively, at the time of connecting the plurality of transmitting connectors 523a and 523b to the plurality receiving connectors 511a and 511b, thereby making it possible to easily prevent the transmitting connectors 523a and 523b from being detached from the receiving connectors 511a and 511b, respectively. As a result, reliability depending on connecting and using the plurality of antennas (ANTs) to the printed circuit board 510 may be improved.

### Sixth Embodiment

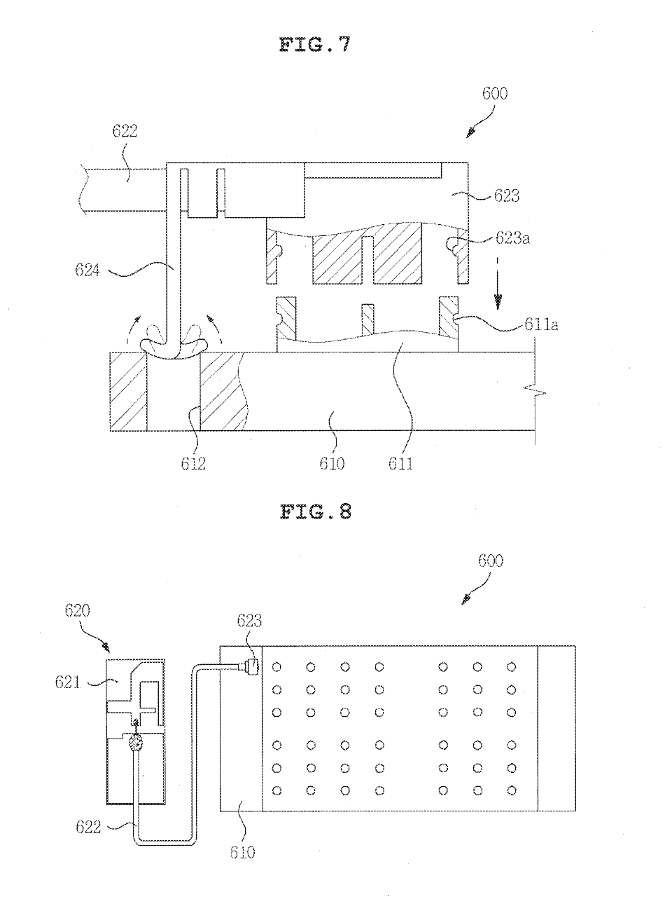

As shown in FIGS. 7 and 8, a radio communication module 600, according to a sixth embodiment of the invention, is configured to include a printed circuit board 610 including a receiving connector 611, an antenna 620 including a transmitting connector 623 connected to the receiving connector 611, and a latching part 624 formed at the transmitting connector 623 and coupled to a fixing part 612 formed in the printed circuit board 610.

According to an embodiment, the printed circuit board 610 includes a general UFL connector mounted as the receiving connector 611 on a substrate and a hole formed as the fixing part 612 at one side of the receiving connector 611 to allow the latching part 624 to be inserted thereinto and coupled thereto.

According to an embodiment, the antenna 620 is configured by soldering and mounting one end of a cable 622 to and on an antenna board 621 and connecting a UFL connector formed, for example, in a circular shape using a thin copper plate as the transmitting connector 623 to the other end of the cable 622. Here, the latching part 624 having a front end divided into two parts and rounded is formed below the transmitting connector 623 in a protrusion form.

According to an embodiment, the latching part 624 is inserted into the fixing part 612 formed in the printed circuit board 610 by an elastic action due to characteristics of a material thereof in a process of connecting the transmitting connector 623 to the receiving connector 611 provided on the printed circuit board 610 and is then coupled and fixed to a lower portion of the printed circuit board 610 while returning to its original form.

According to an embodiment, the latching part 624 is coupled to the lower portion of the printed circuit board 610 while generating a kind of ‘click’ sound in a process in which it returns to its original form. A worker may easily decide whether the transmitting connector 623 has been coupled through this sound.

According to an embodiment, detachment of the transmitting connector 623 from the receiving connector 611 may be easily prevented because of the latching part 624, and the transmitting connector 623 serves as a ground (GND) on a circuit due to a ground with the printed circuit board 610, thereby making it possible to provide a ground reinforcing effect.

Meanwhile, a coupling protrusion 623a is formed on an inner surface of the transmitting connector 623 and a coupling groove 611a having a position and a size corresponding to those of the coupling protrusion 623a is formed in an outer surface of the receiving connector 611 to prevent, together with the latching part 624, detachment of the transmitting connector 623.

### Seventh Embodiment

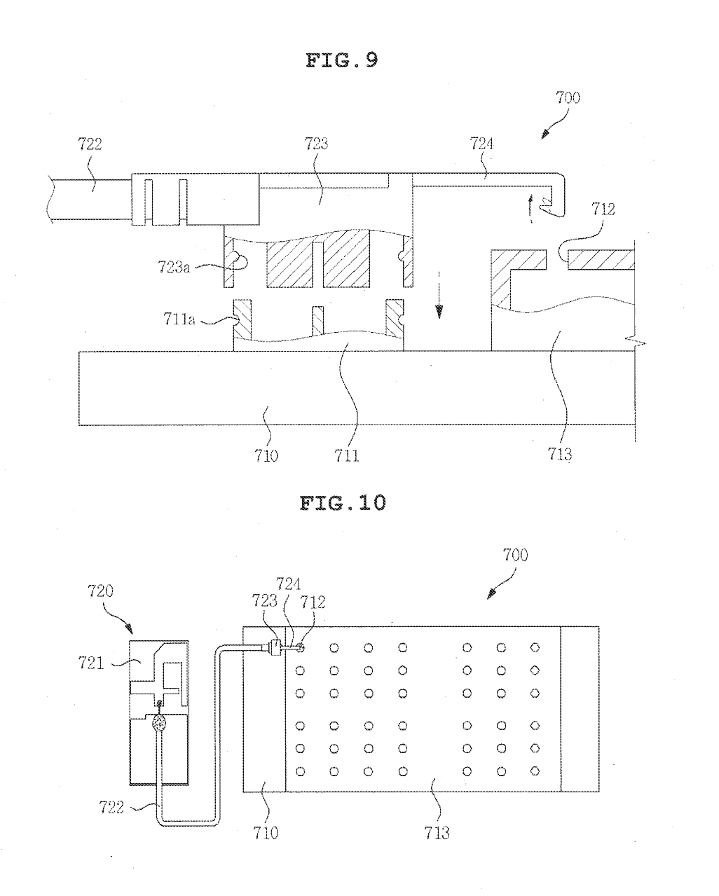

As shown in FIGS. 9 and 10, a radio communication module 700 according to a seventh exemplary embodiment of the present disclosure is configured to include a printed circuit board 710 including a receiving connector 711, a shield can 713 provided on the printed circuit board 710 and shielding, for example, an electromagnetic wave, an antenna 720 including a transmitting connector 723 connected to the receiving connector 711, and a latching part 724 formed at the transmitting connector 723 and coupled to a fixing part 712 formed in the shield can 713.

According to an embodiment, the printed circuit board 710 includes a general UFL connector mounted as the receiving connector 711 on a substrate, the shield can 713 is installed at one side of the receiving connector 711 and made, for example, of a metal, and a hole is formed as the fixing part 712 above the shield can 713 to allow the latching part 724 to be inserted thereinto and coupled thereto.

According to an embodiment, the antenna 720 is configured by soldering and mounting one end of a cable 722 to and on an antenna board 721 and connecting a UFL connector formed, for example, in a circular shape using a thin copper plate as the transmitting connector 723 to the other end of the cable 722. According to at least one embodiment, the latching part 724 having a front end rounded downwardly is formed at an upper end of a side surface of the transmitting connector 723 in a protrusion form.

According to an embodiment, the latching part 724 is inserted into the fixing part 712 formed in the shield can 713 by an elastic action due to characteristics of a material thereof in a process of connecting the transmitting connector 723 to the receiving connector 711 provided on the printed circuit hoard 710 and is then coupled and fixed to an inner portion of the shield can 713 while returning to its original form.

According to an embodiment, the latching part 724 is coupled to the inner portion of the shield can 713 while generating a kind of ‘click’ sound in a process in which it returns to its original form. A worker may easily decide whether the transmitting connector 723 has been coupled through this sound.

According to an embodiment, detachment of the transmitting connector 723 from the receiving connector 711 may be easily prevented because of the latching part 724, and the transmitting connector 723 serves as a ground (GND) on a circuit due to a ground with the shield can 713, thereby making it possible to provide a ground reinforcing effect.

According to an embodiment, a coupling protrusion 723a is formed on an inner surface of the transmitting connector 723 and a coupling groove 711a having a position and a size corresponding to those of the coupling protrusion 723a is formed in an outer surface of the receiving connector 711 to prevent, together with the latching part 724, detachment of the transmitting connector 723.

### Eighth Embodiment

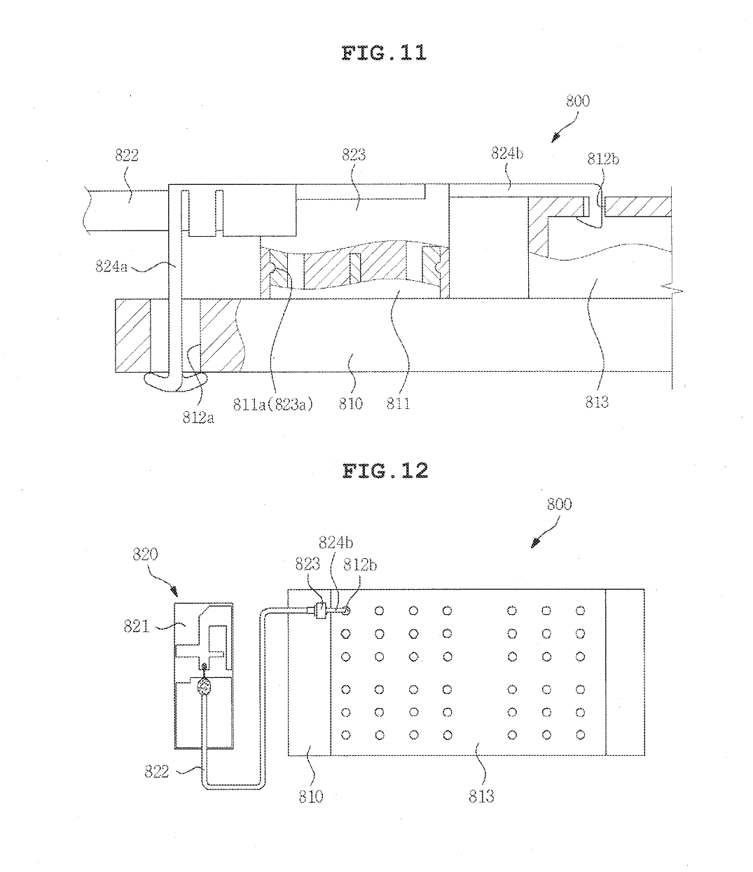

As shown in FIGS. 11 and 12, a radio communication module 800 according to an eighth exemplary embodiment of the present disclosure is configured to include a printed circuit board 810 including a receiving connector 811, a shield can 813 provided on the printed circuit board 810 and shielding, for example, an electromagnetic wave, an antenna 820 including a transmitting connector 823 connected to the receiving connector 811, and latching parts 824a and 824b formed at the transmitting connector 823 and coupled to fixing parts 812a and 812b formed in the printed circuit board 810 and the shield can 813, respectively.

According to an embodiment, for easiness of explanation and convenience of understanding, the latching part coupled to the printed circuit board 810 will be called a first latching part 824a, the latching part 824 coupled to the shield can 813 will be called a second latching part 824b, the fixing part formed in the printed circuit board 810 will he called a first fixing part 812a, and the fixing part formed in the shield can 813 will be called a second fixing part 812b.

According to an embodiment, the printed circuit board 810 includes a general UFL connector mounted as the receiving connector 811 on a substrate and a hole formed as the first fixing part 812a at one side of the receiving connector 811 to allow the first latching part 824a to be inserted thereinto and coupled thereto. In addition, the shield can 813 made, for example, of a metal is installed at one side of the receiving connector 811, and a hole is formed as the second fixing part 812b above the shield can 813 to allow the second latching part 824b to be inserted thereinto and coupled thereto.

According to an embodiment, the antenna 820 is configured by soldering and mounting one end of a cable 822 to and on an antenna board 821 and connecting a UFL connector formed, for example, in a circular shape using a thin copper plate as the transmitting connector 823 to the other end of the cable 822.

According to an embodiment, the first latching part 824a having a front divided into two parts and rounded is formed below the transmitting connector 823 in a protrusion form. In addition, the second latching part 824b having a front end rounded downwardly is formed at an upper end of a side surface of the transmitting connector 823 in a protrusion form.

According to an embodiment, the first latching part 824a is inserted into the first fixing part 812a formed in the printed circuit board 810 by an elastic action due to characteristics of a material thereof in a process of connecting the transmitting connector 823 to the receiving connector 811 provided on the printed circuit board 810 and is then coupled and fixed to a lower portion of the printed circuit board 810 while returning to its original form. In addition, the second latching part 824b is inserted into the second fixing part 812b formed in the shield can 813 and is then coupled and fixed to an inner portion of the shield can 813 while returning to its original form.

According to an embodiment, the first and second latching parts 824a and 824b are coupled to the inner portion of the shield can 813 while generating a kind of ‘click’ sound in a process in which it returns to its original form. A worker may easily decide whether the transmitting connector 823 has been coupled through this sound.

According to an embodiment, detachment of the transmitting connector 823 from the receiving connector 811 may be easily prevented because of the first and second latching parts 824a and 824b, and the transmitting connector 823 serves as a ground (GND) on a circuit due to a ground with the printed circuit board 810 and the shield can 813, thereby making it possible to provide a ground reinforcing effect.

According to an embodiment, a coupling protrusion 823a is formed on an inner surface of the transmitting connector 823 and a coupling groove 811a having a position and a size corresponding to those of the coupling protrusion 823a is formed in an outer surface of the receiving connector 811 to prevent, together with the first and second latching parts 824a and 824b, detachment of the transmitting connector 823.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not he interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “according to an embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A radio communication module, comprising:
a printed circuit board comprising a receiving connector;
a shield can provided on the printed circuit board and configured to shield an electromagnetic wave; and
an antenna comprising a transmitting connector connected to the receiving connector and connected to the printed circuit board through the transmitting connector,
wherein the shield can comprises a blocking part formed at one side surface thereof and protruding toward the transmitting connector and the receiving connector.

2. The radio communication module of claim 1, further comprising:
a reinforcing part configured to reinforce strength of the blocking part.

3. The radio communication module of claim 2, wherein the reinforcing part is formed of a rib formed at an outer portion at which the shield can and the blocking part are connected to each other.

4. The radio communication module of claim 2, wherein the reinforcing part is formed in the blocking part and is formed of a concave-convex part bent in one direction.

5. The radio communication module of claim 1, wherein the blocking part is formed at a central portion of one side surface of the shield can.

6. The radio communication module of claim 1, wherein the blocking part is formed at a side of one side surface of the shield can.

7. The radio communication module of claim 1, wherein the shield can further comprises a bent part formed to allow the blocking part to be adjacent to the transmitting connector.

8. The radio communication module of claim 1, wherein the blocking part comprises a support part formed at a side surface thereof so as to be bent toward the printed circuit board.

9. The radio communication module of claim 1, wherein the antenna comprises:
a cable comprising the transmitting connector provided at one end thereof; and
an antenna board on which the other end of the cable is mounted.

10. A radio communication module, comprising;
a printed circuit board comprising a receiving connector; and
an antenna comprising a transmitting connector connected to the receiving connector and connected to the printed circuit board through the transmitting connector,
wherein the transmitting connector comprises a latching part formed toward the printed circuit board, and a fixing part to which the latching part is coupled is formed in the printed circuit board.

11. The radio communication module of claim 10, wherein the antenna comprises:
the transmitting connector;
a cable connected to the transmitting connector; and
an antenna board comprising the cable mounted thereon.

12. The radio communication module of claim 10, wherein the fixing part is a hole comprising the latching part inserted thereinto and coupled thereto.

13. A radio communication module comprising:
a printed circuit board comprising a receiving connector;
a shield can provided on the printed circuit board and configured to shield an electromagnetic wave; and
an antenna comprising a transmitting connector connected to the receiving connector and connected to the printed circuit board through the transmitting connector,
wherein the transmitting connector comprises a latching part formed toward the shield can, and a fixing part to which the latching part is coupled is formed in the shield can.

14. The radio communication module of claim 13, wherein the antenna comprises;
the transmitting connector;
a cable connected to the transmitting connector; and
an antenna board comprising the cable mounted thereon.

15. The radio communication module of claim 13, wherein the fixing part is a hole having the latching part inserted thereinto and coupled thereto.

16. A radio communication module, comprising:
a printed circuit board comprising a receiving connector;
a shield can provided on the printed circuit board and configured to shield an electromagnetic wave; and
an antenna comprising a transmitting connector connected to the receiving connector and connected to the printed circuit board through the transmitting connector,
wherein the transmitting connector comprises latching parts formed toward the printed circuit board and the shield can, respectively, and fixing parts to which the latching parts are coupled are formed in the printed circuit board and the shield can, respectively.

17. The radio communication module of claim 16, wherein the antenna comprises:
the transmitting connector;
a cable connected to the transmitting connector; and
an antenna board comprising the cable mounted thereon.

18. The radio communication module of claim 16, wherein the fixing part is a hole comprising the latching part inserted thereinto and coupled thereto.
